(19) United States
(12) Patent Application Publication
(10) Pub. No.: US 2020/0409451 A1
(43) Pub. Date: Dec. 31, 2020

(54) PERSONALIZED CONTENT FOR AUGEMENTED REALITY BASED ON PAST USER EXPERIENCE

(71) Applicant: International Business Machines Corporation, Armonk, NY (US)

(72) Inventors: Sougata Mukherjea, New Delhi (IN); Saiprasad Kolluri Venkata Sesha, Bengaluru (IN); Seema Nagar, Bangalore (IN); Kuntal Dey, Vasant Kunj (IN)

(21) Appl. No.: 16/453,548

(22) Filed: Jun. 26, 2019

(51) Int. Cl. G06F 3/01; G06T 19/00; G06K 9/00; G06F 9/451

(52) U.S. Cl. CPC G06F 3/011; G06F 9/453; G06K 9/00671; G06T 19/006

(57) ABSTRACT

One example of a computer-implemented method comprises receiving recorded data of activity of a first user wearing an augmented reality (AR) device; analyzing the recorded data to identify a current task being performed by the first user; and comparing the identified current task to a plurality of prior tasks performed by the first user. Each prior task is stored in a database with corresponding user data collected during performance of the prior task by the first user. The method further comprises, in response to identifying a prior task corresponding to the identified current task based on the comparison, generating personalized content related to the identified current task based on the user data collected during performance of the corresponding identified prior task by the first user; and outputting, for display on the AR device, the generated personalized content.

### BACKGROUND

Augmented Reality (AR) devices have become increasingly popular. One use of AR devices includes showing tutorial videos and/or providing technical help through pre-made videos, images, etc.

### SUMMARY

Aspects of the disclosure may include a computer-implemented method, computer program product, and system of personalizing content displayed in an augmented reality (AR) device. One example of the computer-implemented method comprises receiving recorded data of activity of a first user wearing the AR device; analyzing the recorded data to identify a current task being performed by the first user; and comparing the identified current task to a plurality of prior tasks performed by the first user. Each prior task is stored in a database with corresponding user data collected during performance of the prior task by the first user. The method further comprises, in response to identifying a prior task corresponding to the identified current task based on the comparison, generating personalized content related to the identified current task based on the user data collected during performance of the corresponding identified prior task by the first user; and outputting, for display on the AR device, the generated personalized content.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a high-level block diagram of one embodiment of an example system.

FIG. 2 depicts one embodiment of an example data flow diagram.

FIG. 3 is a high-level block diagram of one embodiment of an example personalization server.

FIG. 4 is a flow chart of one embodiment of an example method of personalizing content displayed on an augmented reality device.

FIG. 5 depicts a cloud computing environment according to an embodiment of the present invention.

FIG. 6 depicts abstraction model layers according to an embodiment of the present invention.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

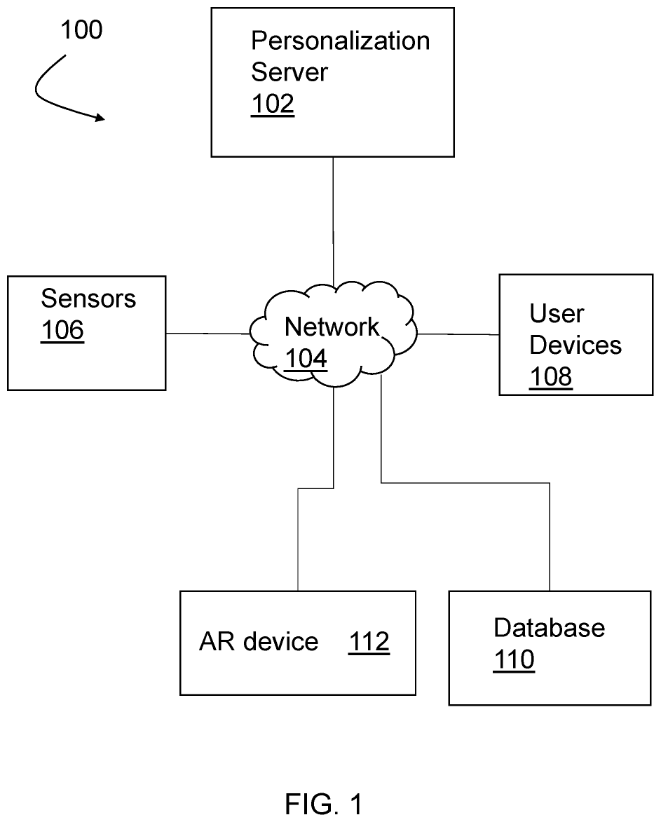

FIG. 1 is a high-level block diagram of one embodiment of an example system 100. The example system 100 includes augmented reality (AR) device 112, one or more sensors 106, user devices 108 and database 110 communicatively coupled with personalization server 102 via network 104.

The network 104 can be implemented using any number of any suitable physical and/or logical communications topologies. The network 104 can include one or more private or public computing networks. For example, network 104 may comprise a private network (e.g., a network with a firewall that blocks non-authorized external access) that is associated with the workload. Alternatively, or additionally, network 104 may comprise a public network, such as the Internet. Thus, network 104 may form part of a packet-based network, such as a local area network, a wide-area network, and/or a global network such as the Internet. Network 104 can include one or more servers, networks, or databases, and can use one or more communication protocols to transfer data between personalization server 102, AR device 112, user devices 108, sensors 106, and database 110. Furthermore, although illustrated in FIG. 1 as a single entity, in other examples network 104 may comprise a plurality of networks, such as a combination of public and/or private networks. The communications network 104 can include a variety of types of physical communication channels or “links.” The links can be wired, wireless, optical, and/or any other suitable media. In addition, the communications network 104 can include a variety of network hardware and software for performing routing, switching, and other functions, such as routers, switches, base stations, bridges or any other equipment that may be useful to facilitate communicating data.

Furthermore, it is to be understood that although sensors 106, AR device 112, user devices 108, and database 110 are depicted in the example of FIG. 1 as being communicatively coupled to the personalization server 102 via the same network 104, for purposes of illustration, the sensors 106, user devices 108, AR device 112 and database 110 can be coupled to the personalization server 102 via separate networks, in other embodiments. For example, in some embodiments, AR device 112 can be communicatively coupled to the personalization server 102 via a cellular network or a wide area network while the database 110 is communicatively coupled to the personalization server 102 via a local area network.

It is to be understood that, although the personalization server 102 and AR device 112 are depicted as separate components in the example of FIG. 1, in other embodiments, the AR device 112 and personalization server 102 are implemented as a single unit. Thus, in such embodiments, the AR device 112 is configured to perform all or part of the functionality described herein as being performed by the personalization server 102.

The personalization server 102 is configured to monitor activity of a user wearing the AR device 112. For example, the personalization server 102 can receive data from sensors incorporated into the AR device 112, such as cameras, microphones, accelerometers, etc., in some embodiments. Additionally, the personalization server 102 can receive data related to user activity from one or more sensors 106 and/or one or more user devices 108. The sensors 106 are sensors external to the AR device 112. For example, the sensors 106 can include cameras, microphones, accelerometers, location sensors (e.g. Global Positioning System receivers), etc. that are external to the AR device 112. The sensors 106 can be fixed in a location such as a security camera or landline office phone. Additionally, or alternatively, the sensors 106 can be included in a portable device and are not fixed to a specific location. The user devices 108 can include one or more mobile devices of the user (such as, but not limited to, a smart phone, tablet, activity tracker, wearable device, etc.) and/or other devices of the user (such as, but not limited to, a desktop computer or a laptop computer). Data provided to the personalization server 102 from the user devices 108 can include, but is not limited to, location data, movement data, image data, video data, audio data, application/program usage data, screenshots, etc. The type of data and sources of data collected by the personalization server 102 can vary depending on the specific implementation. Additionally, it is to be understood that the user can be provided an option to select which type of data to collect and from which sources of data to collect the data.

The personalization server 102 is configured to analyze the data received from one or more of the AR device 112, the sensors 106, and the user devices 108 to identify a current task being performed by the user wearing the AR device 112. For example, the personalization server 102 can analyze images and/or video to identify a task using image analysis techniques known to one of skill in the art, such as, but not limited to, optical character recognition (OCR), edge detection, neural networks, etc. Additionally, or alternatively, the personalization server 102 can identify a task being performed by the user by using natural language processing techniques to analyze text in a document being created by the user. For example, based on analysis of data received from a computer, such as a copy of the document or a screenshot of the document, the personalization server 102 can determine that the user is creating an architecture document (diagram and textual explanation), a webpage, source code for a program, or other document. The task being performed can also include manual activities of varying complexity, such as, but not limited to, building a model, manufacturing a component of a product (e.g. a car, semiconductor chip, etc.), or walking down a hall. In some embodiments, the personalization server 102 is configured to identify the task by comparing the analyzed data to predefined categories and/or tasks previously performed by the user. Additionally, machine learning or artificial intelligence techniques can be used to categorize the current task being performed by the user.

The personalization server 102 is configured to compare the identified current task to a plurality of prior tasks performed by the user. For example, a history of prior task performed by the user can be stored in the database 110. Each of the prior tasks can be categorized and stored with videos, notes, images, and/or other data collected during performance of the prior task by the user. In response to identifying a prior task that corresponds to the current task being performed by the user, the personalization server 102 generates personalized content related to the identified current task based on the data collected during performance by the user of the corresponding prior task. The personalization server 102 outputs the generated personalized content to the AR device 112 for display in the AR content/environment for the user. Thus, the content provided to the user is personalized based on the past experience of the user that is viewing the AR content.

Furthermore, in some embodiments, the personalization server 102 is configured to identify that the user is experiencing difficulty while performing the current task. In some such embodiments, as part of analyzing the data received from the AR device 112, the one or more sensors 106 and/or the one or more user devices 108 to identify the current task of the user, the personalization server 102 can also determine if/when the user is experiencing difficulty in performing the identified current task. For example, the personalization server 102 is configured, in some embodiments, to determine that the user is experiencing difficulty by comparing the amount of time the user is taking to complete all or a part of the current task to a threshold amount of time. The threshold amount of time can be based on an average amount of time for multiple users to complete a similar action, in some embodiments, or an average amount of time for the same user to complete a similar action. If the amount of time the user is taking to complete the current task is greater than the threshold amount of time, then the personalization server 102 determines that the user is experiencing difficulty in such embodiments. It is to be understood that other techniques for identifying difficulty can be used in other embodiments. For example, image analysis of images/videos of the user's facial expressions and/or mannerisms can be used to determine that the user is experiencing difficulty in other embodiments.

In some embodiments, the personalization server 102 is configured to determine if the user experienced difficulty in performing the prior task corresponding to the identified current task. For example, as part of the data stored with each prior task, the database 110 can include an indication of types of difficulty along with actions taken to solve the difficulty for each prior task, in some embodiments. The personalization server 102 is configured, in some embodiments, to generate and/or output the personalized content in response to identifying the corresponding prior task. In other embodiments, the personalization server 102 is configured to generate and/or output the personalized content in response to determining that the user is experiencing difficulty in performing the current task. For example, although the personalization server 102 may identify a corresponding prior task, the personalization server 102 is configured to output the personalized content only if it is determined that the user is experiencing difficulty in performing the current task, in some embodiments. In other embodiments, the personalized content is output and rendered through the AR device 112 regardless of whether it is determined that the user is experiencing difficulty in performing the current task.

In other embodiments, the personalization server 102 is configured to generate and/or output the personalized content in response to determining that the prior task includes data about difficulty experienced by the user in performing the prior task. For example, in such embodiments, in response to determining that the user previously experienced difficulty in the identified prior task, the personalization server 102 generates and outputs the personalized content as a preemptive action to help mitigate any difficulty regardless of whether the user is currently experiencing difficulty in performing the current task.

Furthermore, in some embodiments, the personalization server 102 is configured to output non-personalized content in response to identifying the current task and to generate personalized content in response to identifying a corresponding prior task. Generating the personalized content, in some such embodiments, can include modifying the non-personalized content with the personalized data associated with the prior task or generating separate personalized content to be rendered by the AR device 112 in addition to the non-personalized content. As used herein, the term non-personalized content refers to content (e.g. tips, suggestions, instructions, background information, etc.) that is not based on the user's past experiences, such as guidance or help documents/videos prepared a priori for all users. Additionally, as used herein, personalized content refers to guidance or help documents/videos created based on the data associated with the user's performance of prior tasks. For example, the personalized content can include, in some embodiments, copies of videos, images, documents, etc. recorded or obtained during the performance by the user of the prior task. Additionally, the personalized content can include, in some embodiments, a summary of the data recorded or obtained during the performance by the user of the prior task.

In addition, the personalization server 102 is configured, in some embodiments, to store data recorded or obtained during the performance of the current task in the database 110 for use in generating personalized content for future tasks. Thus, the system 100 is able to provide content through the AR device 112 that is potentially more relevant to a task being performed by the user since the content is personalized based on the actual user's past experience rather than generic content or help documents provided to all users. For example, in response to detecting that the user is experiencing difficulty with a given task, the personalization server 102 can provide content based on a similar difficulty encountered by the same user previously and what the user did to address the difficulty in performing the prior task.

The following example use cases are provided for illustrative purposes only to further explain operation of some embodiments of system 100 and interaction between components of the system 100. The use cases are described with respect to the example system 100 depicted in FIG. 100.

In a first example use case, a user is a system architect that is creating an architecture document including diagrams and textual explanations for a client A. The user is creating the document on the user's laptop computer while wearing an AR device such as AR device 112. The AR device 112 is communicatively coupled to and sharing data with another user device 108, such as the user's laptop computer. Thus, the user interacts with the physical world (e.g. the laptop computer) using content displayed in the AR device 112. This interaction can occur within a session marked inside a session boundary. The session boundary (e.g. start and end times) can be marked automatically or manually. The session boundary is used to record and separate prior tasks for analysis and storage in database 110.

The AR device 112 is configured to obtain data through sensors (e.g. cameras or microphones) of the AR device 112 and/or through a computer-to-AR transmission of data. The obtained data within the session boundary can be assembled and periodically transmitted to the personalization server 102, as discussed above. For example, the captured data can be communicated to the AR device 112 at periodic intervals, in some embodiments, or on an on-going streaming basis, in other embodiments. As part of creating the architecture document in this example use case, the user draws a box on the document and labels it “data distribution service interface layer.” The creation and labeling of the box is captured by the AR device 112, the user device 108 and/or other sensors 106 and is communicated to the personalization server 102.

The personalization server 102 analyzes the data to determine that the user is working on a task of related to a data distribution service interface layer. For example, as discussed above, the personalization server 102 can implement OCR and/or natural language processing techniques to identify the current task. In some embodiments, the personalization server 102 retrieves non-personalized data or content related to data distribution services and sends the non-personalized data to the AR device 112 for rendering. For example, in this example use case, the personalization server 102 outputs help documents regarding data distribution services to the AR device 112. In other embodiments, the non-personalized data is not sent for rendering on the AR device 112.

The personalization server 102 analyzes data in database 110 regarding prior tasks performed by the user and compares the prior tasks to the current task. As a result, the personalization server 102, in this example, determines that the user has previously created a data distribution service interface layer for client B, as well as for client C. Additionally, in this example use case, the personalization server 102 determines, based on data stored in the database, that the user had two areas of struggle/difficulty in creating the data distribution service interface layer for client B and two different areas of struggle/difficulty in creating the data distribution service interface layer for client C.

The personalization server 102 generates personalized content based on the data regarding the corresponding prior tasks performed for client B and client C. For example, the personalization server 102 can generate the personalized content using the user's own session recordings of the prior tasks performed for client B and client C including how the user addressed or solved the areas of struggle during the prior tasks. Thus, any non-personalized content rendered by the AR device 112 can be augmented by including more details on the personal areas of struggle of the user. Furthermore, within the current session, when the personalization server 102 determines that the user is taking an action that is aligned with one of the four identified prior struggle points for the user, the personalization server 102 directs the AR device 112 to display the user's past experience on encountering and resolving the problem in addition to any non-personalized content.

In addition, in this example use case, the personalization server 102 continues to monitor activity of the user and determines that the user is a describing a new sub-action, within the task of data distribution service interaction layer, which describes a data normalization technique. The personalization server 102 further determines that the user is taking longer than a threshold amount of time to complete the data normalization technique and, thus, is experiencing difficulty with completing this sub-action. The personalization server 102 further determines that the user has not performed prior tasks and/or has not experienced past difficulty with actions related to data normalization techniques. Thus, the personalization server 102 outputs non-personalized content regarding existing data normalization techniques for rendering on the AR device 112 and records the user's struggle/actions in completing the data normalization technique. The recorded actions in completing the data normalization technique are stored in database 110 with an indication noting the area of struggle for use in providing personalized content to the user when completing future related tasks.

For example, when the user attempts to create a data normalization subsection within a data distributing service interaction layer for a client D, the personalization server 102 retrieves the prior recorded actions or a summary of the prior recorded actions to provide the user's own physical activities (experience) with the project for client A on the AR device 112. Thus, the physical reality is migrated with the virtual reality based on the user's past experience. The user's past experience can be shown in addition to also rendering the same non-personalized content regarding existing data normalization techniques.

Continuing with this example use case, the personalization server 102 continues to monitor the user's activities during performance of the task for client D. Based on analysis of the user's activities for client D, the personalization server 102 identifies that the user only experienced difficulty with a smaller part of the data normalization sub-action than when performing the task for client A, B, and/or C and records this updated information in the database 110. Subsequently, when performing a similar task for a client E, the personalization server 102 generates personalized content based only on common struggle points across each of the prior activities for clients A, B, C, and D, in some embodiments. Thus, in such embodiments, only the content for common struggle points are rendered in the AR device 112 when performing the task for client E. In other words, the personalization server 102 learns and updates the personalized content based on the changing experience and proficiency of the user.

Additionally, in some embodiments, personalized content for the user can be incorporated into non-personalized data presented to other users. For example, if the personalization server 102 determines that a threshold number or percentage of users is experiencing difficulty or struggling with the same area, then the personalization server 102, in some embodiments, updates the non-personalized data to include material from the user's personalized past experiences. Thus, the user's personalized experiences in addressing the common struggle point is made available to all users. For example, in some such embodiments, the personalization server 102 is configured to modify the non-personalized content to include some or all of the most relevant, or most common/frequent, or most used personalized content from other users to modify the non-personalized content made available to all users. In such embodiments, the personalization server 102 is able to further increase the relevance of the non-personalized data by incorporating personal experiences from one or more other users.

In a second example use case, a second user is walking on a floor while wearing the AR device 112. The AR device 112 renders a floor map of the floor while the second user is walking on the floor. Thus, initially, the AR device 112 is only displaying non-personalized content (i.e. the floor map). Based on analyzing data collected from sensors in the AR device 112 and/or other sensors located on the floor, the personalization server 102 determines that the second user stumbled or fell at a specific point in the floor. The personalization server 102 stores this information in the database 110 related to a task of walking on the floor. Then, subsequently, when the second user is walking on the same floor at a later point in time, the personalization server 102 identifies that the user is performing the same task of walking on the floor and identifies the previous struggle in completing the task (i.e. falling/stumbling at the specific point in the floor). During the subsequent performance of the task, the personalization server 102 generates personalized content for performing the task based on the user's past experience. In particular, in this example, the personalization server 102 generates a warning and/or displays a video of the user's prior stumble/fall at the user approaches the specific point in the floor. Additionally, if the personalization server 102 determines that a sufficient number of users are experiencing the same difficulty at the specific point in the floor, the personalization server 102 can update the non-personalized content (e.g. the floor map) with personalized data from the second user (e.g. a warning and/or video of the possibility of stumbling/falling).

In a third example use case, a third user has previously written a particular program code or code snippet while wearing an AR device 112 for a previous project to implement a solution to a problem. The third user is currently wearing the AR device 112 while writing program code to solve a current related problem. The personalization server 102 is configured to analyze data received from the AR device 112 and/or a computer the user is using to write the code. Based on the analysis of the data, the personalization server 102 determines that Application Programming Interface (API) documentation related to the code structure being written by the third user is being displayed by the AR device 112. The personalization server 102 further analyzes user history data of the user's prior experiences in the database 110 and determines that the third user has implemented this API previously and had difficulty previously in implementing the API. In response to determining that the third user has previously implemented the API and had previous difficulty, the personalization server 102 generates personalized content based on the stored data regarding the third user's prior experience with the API. The personalized content includes information regarding how the third user solved the difficulty in the previous experience with the API.

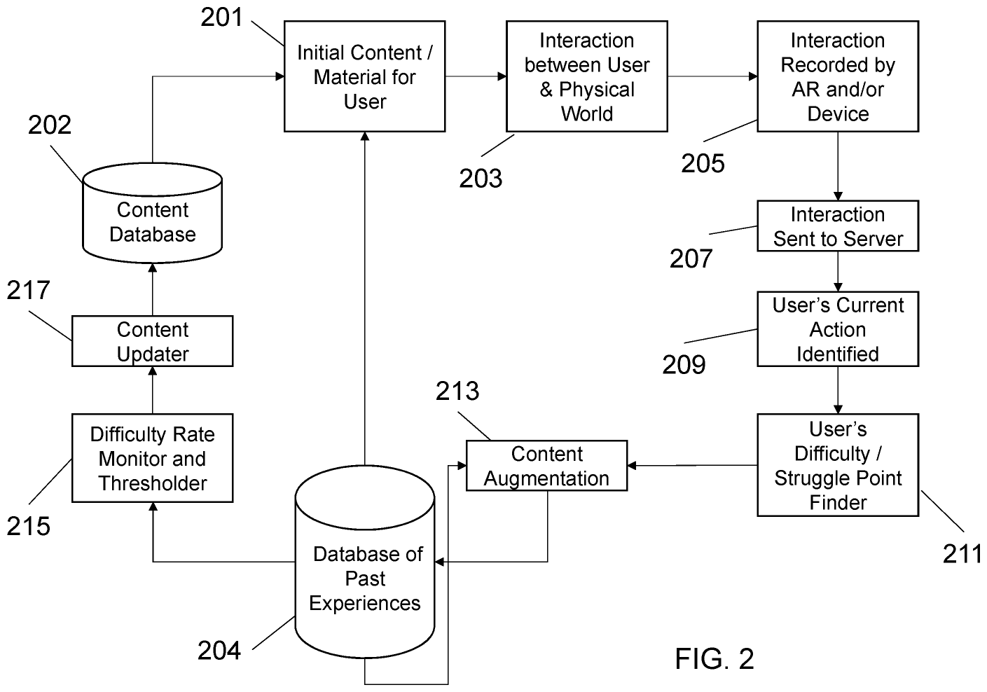

The above example use cases are provided only for illustrative purposes and it is to be understood that the system 100 can be implemented in other scenarios. Furthermore, for purposes of explanation, an example data flow diagram 200 of data processing for system 100 is described below with respect to FIG. 2. At block 201, initial content is retrieved from a content database 202. The initial content can include non-personalized content or data related to a task being performed by the user. The initial content can be automatically retrieved by an AR device of the user or the user can manually select all or part of the initial content. At block 203, the initial content is displayed in the AR device and the user interacts with the physical world using the initial content displayed in the AR device. At block 205, the interaction of the user is recorded by the AR device and/or another device or sensor (such as sensors 106 or user devices 108). At block 207, the recorded interaction is sent to the personalization server. At block 209, the personalization server analyzes the recorded interaction to identify and monitor the user's current action or task. At block 211, the personalization server determines that the user is struggling with an aspect of performing the current action or task, as discussed above.

At block 213, the personalization server generates augmented content (also referred to herein as personalized content) based on data stored in database 204 regarding the user's past experiences. It is to be understood that in some embodiments, the initial content is stored on a separate database from the data regarding the user's past experiences, as shown in FIG. 2. In other embodiments, the content and data regarding the user's past experiences are stored on the same database, as depicted in the example of FIG. 1. Additionally, the personalization server stored the recorded interaction of the current activity and augmented content on the database 204 for use in future scenarios. The augmented content is provided to the AR device at block 201 for display with the initial content. As discussed above, the augmented content includes personalized data related to the user's current task and/or struggle.

Furthermore, in the example of FIG. 2, the personalization server monitors, at block 215, the rate at which a plurality of users experience the same difficulty and determines if the number of user or percentage of users exceeds a threshold. At block 217, in response to determining that the threshold is exceeded, the personalization server updates the initial content based on the augmented content and stores the updated initial content in the database 202.

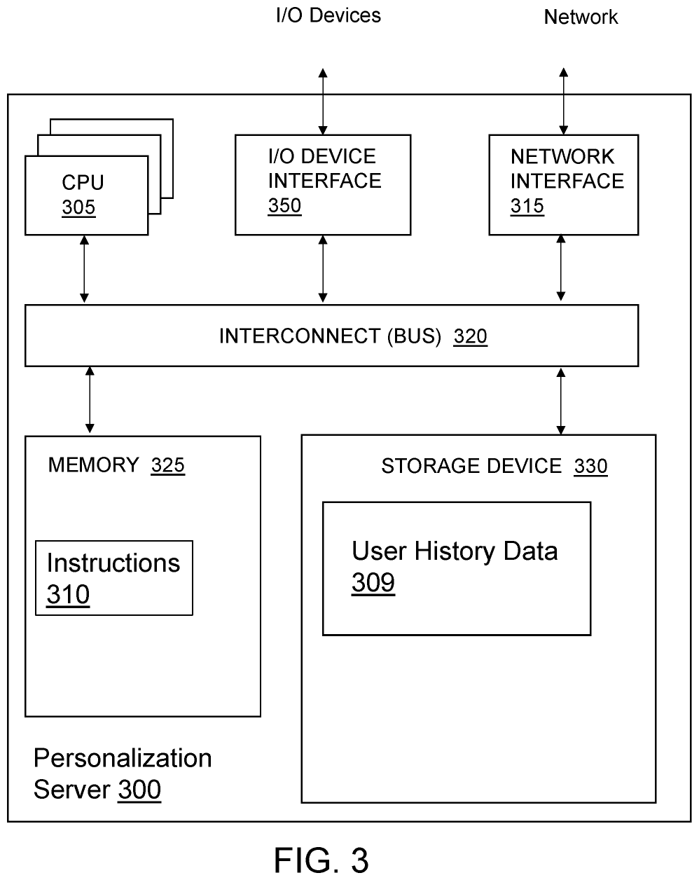

FIG. 3 is a high-level block diagram of one embodiment of an example personalization server 300. The personalization server 300 can be implemented as personalization server 102 in FIG. 1. In the example shown in FIG. 3, the personalization server 300 includes a memory 325, storage 330, an interconnect (e.g., BUS) 320, one or more processors 305 (also referred to as CPU 305 herein), and a network interface 315. It is to be understood that the personalization server 300 is provided by way of example only and that the personalization server 300 can be implemented differently in other embodiments. For example, in other embodiments, some of the components shown in FIG. 3 can be omitted and/or other components can be included.

Each CPU 305 retrieves and executes programming instructions stored in the memory 325 and/or storage 330. The interconnect 320 is used to move data, such as programming instructions, between the CPU 305, storage 330, network interface 315, and memory 325. The interconnect 320 can be implemented using one or more busses. The CPUs 305 can be a single CPU, multiple CPUs, or a single CPU having multiple processing cores in various embodiments. In some embodiments, a processor 305 can be a digital signal processor (DSP). Memory 325 is generally included to be representative of a random access memory (e.g., static random access memory (SRAM), dynamic random access memory (DRAM), or Flash). The storage 330 is generally included to be representative of a non-volatile memory, such as a hard disk drive, solid state device (SSD), removable memory cards, optical storage, or flash memory devices. In an alternative embodiment, the storage 330 can be replaced by storage area-network (SAN) devices, the cloud, or other devices connected to the personalization server 400 via a communication network coupled to the network interface 315.

In some embodiments, the memory 325 stores instructions 310 and the storage 330 stores user history data 309. This user history data 309 can include historical activity of the user such as recorded data of prior performed tasks and struggle points, as discussed above. In other embodiments, the instructions 310 and the user history data 309 are stored partially in memory 325 and partially in storage 330, or they are stored entirely in memory 325 or entirely in storage 330, or they are accessed over a network via the network interface 315. Additionally, as discussed above, the user history data 309 can be stored in a database or memory device accessed via the network interface 315 rather than being locally attached or integrated with the personalization server 300.

When executed, the instructions 310 cause the CPU 305 to analyze the data received over the network interface 315 as well as user history data 309 in order to perform the functionality discussed above with respect to personalization server for generating personalized content based on identified tasks and/or struggle points. The instructions 310 further cause the CPU 305 to output signals and commands to an AR device worn by the user via network interface 315. The output signals and commands contain information related to rendering the personalized content (also referred to herein as augmented content). Further details regarding operation of the personalization server 300 are also described below with respect to method 400.

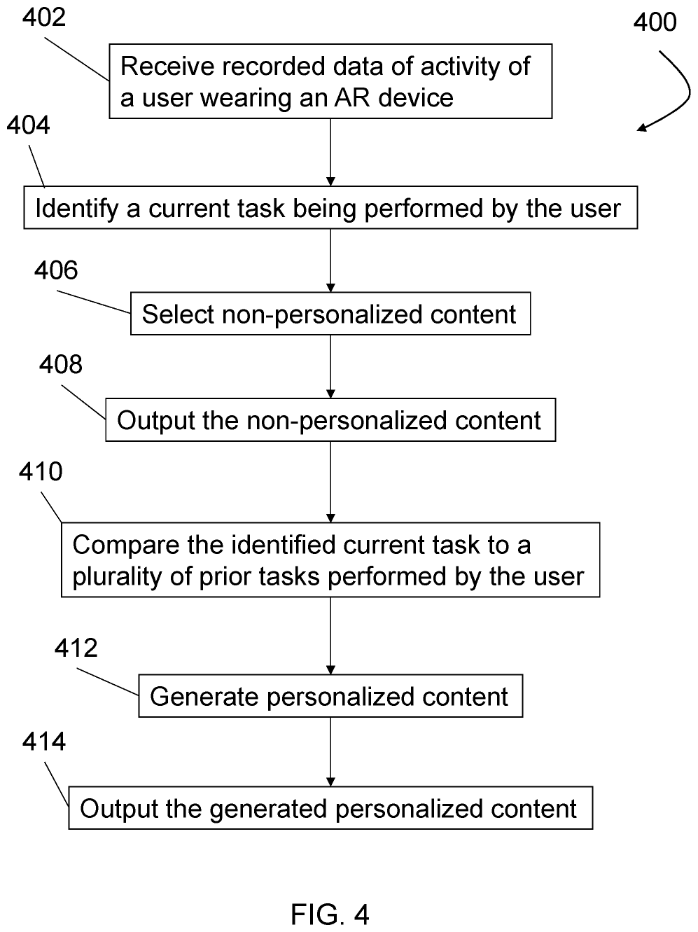

FIG. 4 is a flow chart of one embodiment of a method 400 of personalizing content displayed on an AR device. The method 400 can be implemented by a personalization server, such as personalization server 102 or 300 described above. For example, the method 400 can be implemented by a CPU, such as CPU 305 in personalization server 300, executing instructions, such as instructions 310. It is to be understood that the order of actions in example method 400 is provided for purposes of explanation and that the method can be performed in a different order in other embodiments. Similarly, it is to be understood that some actions can be omitted or additional actions can be included in other embodiments. For example, in some embodiments, blocks 406 and 408 are optionally omitted.

At block 402, recorded data of activity of a user wearing the AR device is received. For example, the data can be received over a network, such as network 104. Furthermore, the data can include video, images, accelerometer data, documents, etc., as discussed above. Additionally, as discussed above, the recorded data can be captured and sent to the personalization server by one or more of the AR device, sensors external to the AR device, and/or other user devices, as discussed above.

At block 404, the personalization server analyzes the recorded data to identify a current task being performed by the user, as discussed above. At block 406, the personalization server can select non-personalized content for display on the AR device based on the identified current task, as discussed above. At block 408, the selected non-personalized content is output for display on the AR device. However, in some embodiments, block 406 and 408 can be omitted.

At block 410, the personalization server compares the identified current task to a plurality of prior tasks performed by the user, as discussed above. Each prior task can be stored in a database with corresponding user data collected during performance of the prior task by the user, as discussed above. The user data collected during performance of the prior task by the user can include, in some embodiments, one or more of a video, an image, a screenshot, or a document created during performance of the prior task.

At block 412, in response to identifying the prior task corresponding to the identified current task based on the comparison, the personalization server generates personalized content related to the identified current task based on the user data collected during performance of the corresponding identified prior task by the user, as discussed above. In some embodiments, generating the personalized content includes modifying the non-personalization content to include the user data from the prior task. In other embodiments, the generated personalized content is separate from the non-personalized content. At block 414, the personalized content is output to the AR device for display on the AR device.

As discussed above, analyzing the recorded data can include identifying when the user is experiencing difficulty while performing the current task. For example, as discussed above, identifying that the user is experiencing difficulty can include, in some embodiments, comparing an amount of time for the user to complete the current task with a threshold and, in response to determining that the amount of time exceeds the threshold, determining that the user is experiencing difficulty. In some embodiments, the threshold can be based on an average amount of time taken by the user to complete one or more corresponding prior tasks, as discussed above. In other embodiments, the threshold can be based on an average amount of time for a plurality of users to complete one or more similar tasks, as discussed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

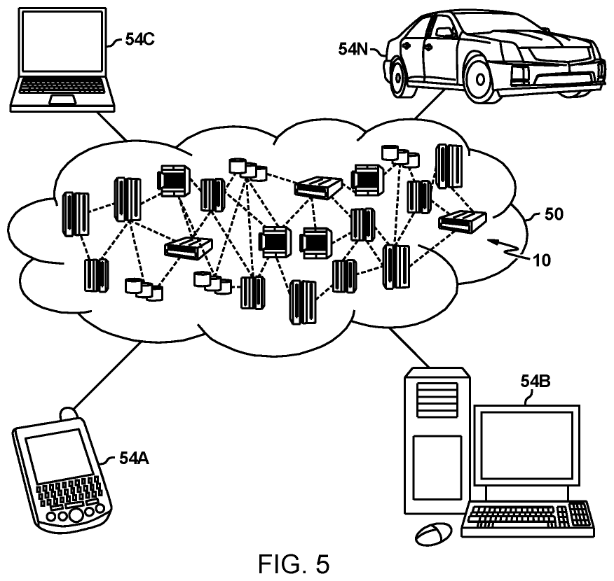

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

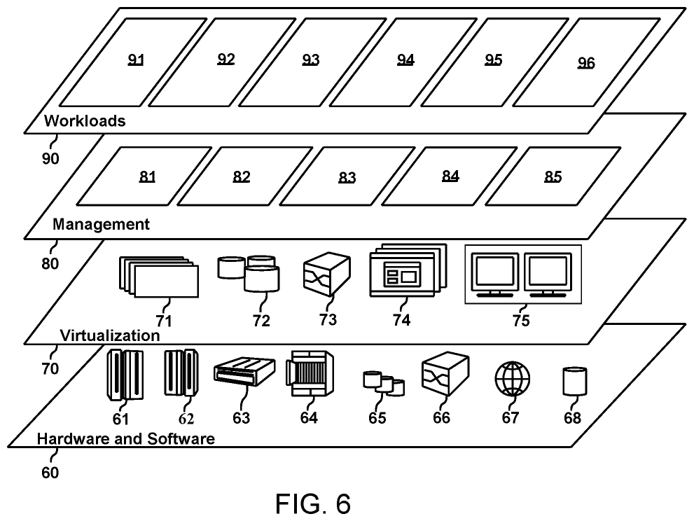

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and personalization processing 96.

Furthermore, the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A method of personalizing content displayed in an augmented reality (AR) device, the method comprising:
receiving recorded data of activity of a first user wearing the AR device;
analyzing the recorded data to identify a current task being performed by the first user;
identifying a plurality of prior tasks performed by the first user that correspond to the identified current task, each respective prior task of the plurality of prior tasks stored in a database with corresponding user data collected during performance of the respective prior task by the first user, wherein the corresponding user data for each respective prior task includes one or more indications associating one or more actions taken by the first user during performance of the respective prior task with one or more corresponding areas of struggle, each of the one or more areas of struggle comprising a subsection of the respective prior task;
generating personalized content related to the identified current task based on the user data collected during performance of the corresponding identified plurality of prior tasks by the first user, wherein the generated personalized content is based only on user data of the first user associated with at least one area of struggle of the one or more areas of struggle that is common to each of the plurality of prior tasks performed by the first user; and
outputting, for display on the AR device, the generated personalized content.

2. The method of claim 1, wherein the user data collected during performance of the prior task by the user includes one or more of a video, an image, a screenshot, or a document created during performance of the prior task.

3. The method of claim 1, further comprising identifying that the first user is experiencing difficulty while performing the current task based on analysis of the recorded data.

4. The method of claim 3, wherein identifying that the first user is experiencing difficulty while performing the current task includes:
comparing an amount of time for the first user to complete the current task with a threshold; and
in response to determining that the amount of time exceeds the threshold, determining that the first user is experiencing difficulty.

5. The method of claim 4, wherein the threshold is based on an average amount of time taken by the first user to complete one or more corresponding prior tasks.

6. The method of claim 3, further comprising:
determining that a number of users that have experienced the same difficulty as the first user exceeds a threshold; and
in response to determining that the number of users experiencing the same difficulty exceeds the threshold, modifying non-personalized content related to the identified task based on the generated personalized content of the first user.

7. The method of claim 1, further comprising:
selecting non-personalized content in response to identifying the current task; and
outputting the non-personalized content for display on the AR device.

8. A system comprising:
a network interface configured to receive and transmit data over a network; and
a processor communicatively coupled to the processor, wherein the processor is configured to:
identify a current task being performed by a user wearing an augmented reality (AR) device based on analysis of recorded data of the user's activity, the recorded data received via the network interface;
identify a plurality of prior tasks performed by the user that correspond to the current task, each respective prior task of the plurality of prior tasks stored in a database with corresponding user data collected during performance of the respective prior task by the user, wherein the corresponding user data for each respective prior task includes one or more indications associating one or more actions taken by the user during performance of the respective prior task with one or more corresponding areas of struggle, each of the one or more areas of struggle comprising a subsection of the respective prior task;
generate personalized content related to the identified current task based on the user data collected during performance of the corresponding identified plurality of prior tasks by the user, wherein the generated personalized content is based only on user data associated with at least one area of struggle of the one or more areas of struggle that is common to each of the plurality of prior tasks performed by the user; and
output the generated personalized content via the network interface to the AR device for display on the AR device.

9. The system of claim 8, wherein the user data collected during performance of the prior task by the user includes one or more of a video, an image, a screenshot, or a document created during performance of the prior task.

10. The system of claim 8, wherein the recorded data is received from one or more of the AR device, a sensor external to the AR device, or a user device of the user separate from the AR device.

11. The system of claim 8, wherein the processor is further configured to identify that the user is experiencing difficulty while performing the current task based on analysis of the recorded data.

12. The system of claim 11, wherein the processor is configured to identify that the user is experiencing difficulty while performing the current task by:
comparing an amount of time for the user to complete the current task with a threshold; and
in response to determining that the amount of time exceeds the threshold, determining that the user is experiencing difficulty.

13. The system of claim 12, wherein the threshold is based on an average amount of time taken by the user to complete one or more corresponding prior tasks.

14. The system of claim 8, wherein the processor is further configured to:
select non-personalized content in response to identifying the current task; and
output the non-personalized content for display on the AR device.

15. A computer program product comprising a computer readable storage medium having a computer readable program stored therein, wherein the computer readable program, when executed by a processor, causes the processor to:
identify a current task being performed by a user wearing an augmented reality (AR) device based on analysis of recorded data of the user's activity while performing the current task;
identify a plurality of prior tasks performed by the user that correspond to the current task, each respective prior task of the plurality of prior tasks stored in a database with corresponding user data collected during performance of the respective prior task by the user, wherein the corresponding user data for each respective prior task includes one or more indications associating one or more actions taken by the user during performance of the respective prior task with one or more corresponding areas of struggle, each of the one or more areas of struggle comprising a subsection of the respective prior task;
generate personalized content related to the identified current task based on the user data collected during performance of the corresponding identified plurality of prior tasks by the user, wherein the generated personalized content is based only on user data associated with at least one area of struggle of the one or more areas of struggle that is common to each of the plurality of prior tasks performed by the user; and
output the generated personalized content to the AR device for display on the AR device.

16. The computer program product of claim 15, wherein the user data collected during performance of the prior task by the user includes one or more of a video, an image, a screenshot, or a document created during performance of the prior task.

17. The computer program product of claim 15, wherein the computer readable program is further configured to cause the processor to identify that the user is experiencing difficulty while performing the current task based on analysis of the recorded data.

18. The computer program product of claim 17, wherein the computer readable program is further configured to cause the processor to identify that the user is experiencing difficulty while performing the current task by:
comparing an amount of time for the user to complete the current task with a threshold; and
in response to determining that the amount of time exceeds the threshold, determining that the user is experiencing difficulty.

19. The computer program product of claim 18, wherein the threshold is based on an average amount of time taken by the user to complete one or more corresponding prior tasks.

20. The computer program product of claim 15, wherein the computer readable program is further configured to cause the processor to:
select non-personalized content in response to identifying the current task; and
output the non-personalized content for display on the AR device.
